(19) United States
(12) Patent Application Publication
(10) Pub. No.: US 2004/0158960 A1
(43) Pub. Date: Aug. 19, 2004

(54) Adjustable cap panel with kit

(76) Inventor: Zellna T. Shaw, Lakeland, GA (US)

Correspondence Address: Brian D. Bellamy, P.O. Box 1997, Thomasville, GA, 31799-1997, US

(21) Appl. No.: 10/777,925

(22) Filed: Feb. 12, 2004

Related U.S. Application Data
(60) Provisional application No. 60/446,454, filed on Feb. 12, 2003.

(51) Int. Cl. A61G 17/00

(52) U.S. Cl. 27/14

(57) ABSTRACT

A method and kit for providing a cap panel and accessories for a casket comprises a panel of flexible plastic or board that is covered in a removable fabric. The lid of the casket where the cap panel will be displayed is measured using an included measuring device, and the panel is cut to adjust the panel size after removing the decorative fabric. After adjusting the size of the panel, the panel is re-covered in the fabric by attaching the fabric at the backside of the panel. Thereafter, the panel is inserted onto the casket lid by tucking the cap panel with a provided device into a framing area situated about the central area on the lid. The cap panel may be stored in a frame or packaging pending need for use on a casket. The framed or packaged cap panel combined with a pillow cover and drape provides a pre-need package for uniquely meeting the specific interests of a person while providing for flexibility of casket selection at the time of need.

### PRIORITY CLAIM

The present application claim benefit of the filing date of United States provisional patent application No. 60/446,454 filed on Feb. 12, 2003.

### BACKGROUND OF THE INVENTION

1. Field of the Invention

The present invention relates generally to personalized funeral accessories and casket decor including casket interiors. More particularly, the invention relates to an adjustable casket lid panel and method and, further, to an assembly of the adjustable casket lid panel into a kit or decorative frame for pre-need selection or display.

2. Description of the prior Art

Advance planning is a way of life, but is very often neglected in making advance funeral and burial preparations that will spare loved ones of the deceased additional anxiety at the time of the funeral. The grieving loved ones are generally faced with making decisions regarding a significant purchase at a time when extensive thought and consideration into the nature of the purchase may not be made with careful deliberation. Advance planning gives every individual the opportunity to assemble information of vital importance, such as expressing personal wishes concerning funeral services as well as selecting and purchasing such things as a casket, vault, and other personal funeral items.

Burial caskets often include a decorative lid underside, or casket top interior, for purposes of viewing. In particular, during the viewing period, the casket lid is often opened to permit viewing of the deceased. The lid may fully open, or partially open over the top portion of the body. While open, the casket top interior is prominently displayed. It is thus desirable for the casket top interior, or at least the portion that opens for the viewing, to be aesthetically pleasing. Caskets have traditionally been provided with decorative upholstery which covers the interior of the lid and container portions of the casket. Upholstery for the lid has traditionally comprised a central panel surrounded by framing, commonly referred to as “puffing.” The upholstery is available in a variety of colors and patterns.

It is desirable for a mortician to make available a wide selection of aesthetic combinations. For this reason, it has been proposed to provide easily removable panels Replaceable casket interiors and cap panels have been known and used in the past. However, it is believed that the prior art is short of suggestions with regard to the provision of a casket cap interior panel kit as a discrete product, for shipment to a funeral director and for keeping by the funeral director as inventory for mounting into a casket cap recess as the need arises. Likewise, a need exists for customizing and personalizing casket cap panels for insertion into a variety of casket designs according to preference, and a product is needed to accommodate funeral director's need for such personalization.

As such, it may be appreciated that there continues to be a need for a customizable casket cap panel and kit therefor in which the appearance of the cap panel may be personalized and the cap panel may be readily obtained from inventory on-hand by a funeral director regardless of the choice of the casket.

Memorial products are well known in the prior art. For example, U.S. Pat. No. 6,039,576 issued to Gabig et al provides for a product display board for display of a plurality of product lines of memorial products having a plurality of design features. The product display board includes samples of memorial products of each product line arranged in rows with related design features arranged in columns.

U.S. Pat. No. 3,928,928 issued to Calloused provides for an audio-visual memorial that comprises a support for carrying a memorial object and a cover carried on the support for movement between a first position in which the memorial object is covered and a second position in which the memorial object is exposed to view.

In addition, U.S. Pat. No. 6,088,973 issued to Weiss provides for monuments, markers and columbaria with improved display indicia wherein a monument is shown having a moveable element mounted in an opening therein for displaying information.

U.S. Pat. No. 6,223,404 B1 issued to Fant et al that provides for a decorative casket cover system wherein a substrate material is cut into panels that have shapes that correspond to the sections of the casket surface.

U.S. Pat. No. 6,502,287 B2 issued to Mlchaud et al provides a casket interior kit composed of a casket lid liner panel, several lengths of panel edges, a liner cloth set, and a pillow arranged in a box for delivery to a funeral parlor or warehouse.

U.S. Pat. No. 4,357,741 issued to Winburn et al provides a decorative lining for a casket lid comprising a panel bordered along at least two edges by framing, and a tabbed fastening arrangement for securing the panel to the lid.

Finally, U.S. Pat. No. 6,151,762 issued to Cox provides a casket lid panel including a panel base and a plurality of folded-under tabs. Each of the folded-under tabs is integrally formed with the panel base and is folded under a portion of the panel base, thereby defining at least a portion of a periphery of the panel base. Each of the folded-under tabs is furthermore affixed to the second side of the panel base. The section of flexible material substantially covers the first side of the panel base and is affixed to said folded-under tabs.

Hence it is seen that none of these previous inventions provide the benefits intended with the present invention, such as providing a pre-need or an immediate need personalized funeral accessory package comprising a casket lid panel, pillow cover and casket drape. Further, it is seen that none of these previous inventions provide a casket cap panel insert or kit therefore in which the cap panel is customizable to fit a variety of casket and may be personalized.

### SUMMARY OF THE INVENTION

The present invention provides for novel and unique personalized funeral accessories that are designed and configured to comprise a funeral accessory package and kit. In addition, the present invention also provides for a quick and easy method to adjust the casket cap panel to fit a central interior portion of any size casket lid.

Advance planning for funeral and burial preparations allows an individual not only the opportunity to assemble information of vital importance, but also the opportunity to express personal wishes with regard to their funeral service, as well as the selection of a casket, vault and numerous personalized items reflecting one's life. The pre-need personalized funeral accessory package and kit of the present invention includes a novel and unique adjustable and covered casket cap panel with decorative features, as well as tools and instructions for using the adjustable panel including a measuring device, tucking device, and means for pinning a fabric covering to the panel. In addition, a decorative pillow cover and casket drape may be included. The items may be packaged in a box or plastic bag, or, optionally framed, for hanging on the wall to display the casket drape, pillow cover, and cap panel.

The personalized packages may include Scottish themed packages or like indicating a person's heritage, ethnic background, organizational or fraternal affiliation. Such affiliated groups may utilize tartans, crests, insignia or other specific identifying designations that could be included on the cap panel fabric, pillow cover or drape. These will be designed for the individual specifications of a purchaser and all of the items in the package will reflect these specifications including a color scheme. Thereby, the customizable features of the cap panel will promote greater personalization according to individual need and desire.

The present invention will also offer flexibility for combination with special interest packages that will include the casket lid panel, pillow cover and casket drape in designer fabrics, special interests graphic fabrics, and airbrushed artworks. The designer fabrics will include brocades, velvets, velours, and others in a variety of colors and prints. The special interest graphic fabrics will include themes for hunting, sports, animals, infant and youth designs, as well as others. The airbrushed art could feature photographic art, the family pet, pastoral scenes, whimsical motifs and others. These will be packaged in poly hang-up bags for easy display by funeral services, casket stores, and other retail outlets.

Accordingly, it is the object of the present invention to provide for a pre-need or immediate need personalized funeral accessory packages with an adjustable cap panel that will overcome the drawbacks, disadvantages, and shortcomings of prior funeral accessories thereof.

It is yet another object of the present invention to provide a pre-need funeral accessory package that may be customized by the individual to express their personal wishes and desires.

Still another object of the present invention is to provide for pre-need personalized funeral accessories that are aesthetically pleasing and may be customized to reflect personal wishes and desires, as well as immediate need funeral accessories that may be embroidered to customize to a specific individual need, such as firefighters, policemen, sports, musical, or the like.

A further object of the present invention is to provide for an “immediate need” funeral accessory package that aids in selection of the necessary funeral accessories for families faced with making an unexpected significant purchase during a time of shock, grief and sadness.

Still a further object of the present invention, to be specifically enumerated herein, is to provide personalized funeral accessories and a novel and unique method to adjust the casket lid panel. The casket lid panel is designed to fit most caskets with instructions and tool for making adjustments included in each package. The wood frame in which the entire package is assembled makes an attractive wall hanging for any home or office and speaks of the individual's heritage and/or personal interests.

The present invention meets the requirements of functionality, simplicity, aesthetically pleasing design and low initial cost.

The foregoing has outlined some of the more pertinent objects of the invention. These objects should be construed to be merely illustrative of some of the more prominent features and applications of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention taken in conjunction with the accompanying drawings.

### BRIEF DESCRIPTION OF THE DRAWINGS

FIG. 1 is a plan view of a plastic packaging and funeral accessory kit including an adjustable casket cap panel assembled in accordance with the present invention.

FIG. 1B is a disassembled view of the cap panel insert kit shown packaged in FIG. 1, including a cap panel, a removable fabric cover, directions for adjustment, a measuring device, a cutting device, and a tucking device.

FIG. 2 is a front plan view illustrating an optional wall display of a funeral accessory kit in accordance with an embodiment of the invention.

FIG. 3 is a perspective illustration of a cap panel insert and pillow cover from the kit of the present invention inserted into a casket interior and a casket drape on the exterior.

### DETAILED DESCRIPTION OF THE INVENTION

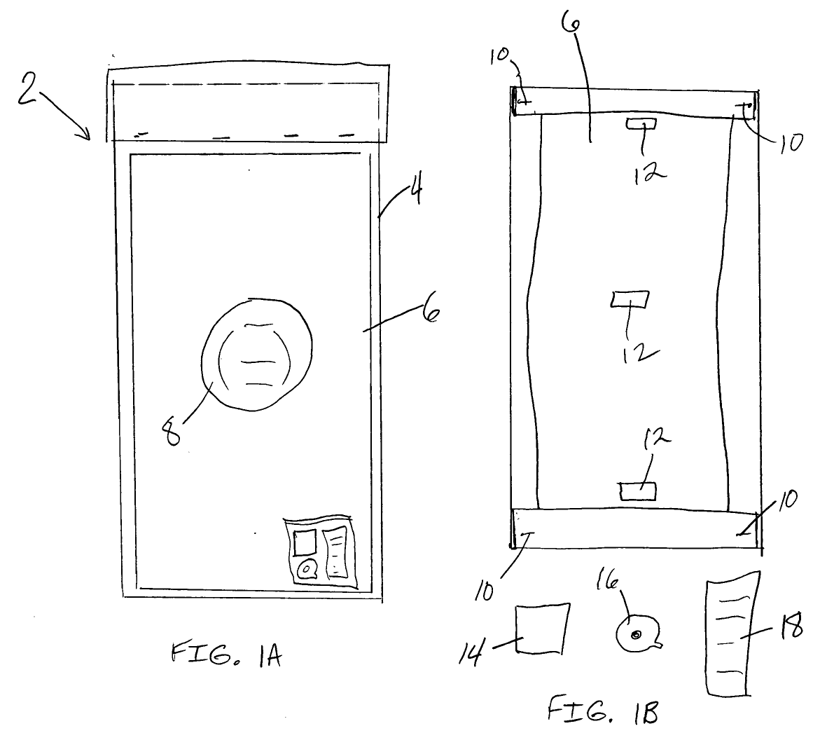

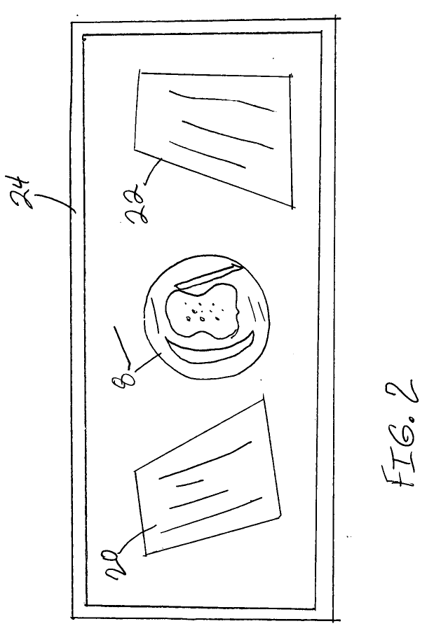

Referring to figures, FIGS. 1A and 1B show an embodiment of an adjustable cap panel insert kit 2 assembled in accordance with the invention. The elements of the kit are packaged and contained for storage in a box or bag as shown in FIG. 1A. In particular, a transparent plastic bag 4 may be used for inexpensive and easy storage and access. The elements of the kit packaged within the package include an adjustable cap panel 6, fabric covering 8, attachment pins 10, hook and loop attachment devices 12, a tucking device 14, a measuring device 16 and instructions 18. FIG. 1B shows these elements removed from the packaging. Other potential elements of the kit include a cutting device, a pillow cover 20, and a casket drape 22. The various elements may be packaged into a frame 24 as shown in FIG. 2 for pre-need display.

The adjustable cap panel 6 is constructed on a flexible flat panel of corrugated plastic material or board material. The corrugated plastic is pliable and may be readily cut using scissors or other cutting blade or device. A cutting device such as a razor blade or knife may optionally be included in the kit for the convenience of the customer. The instructions will explain the method for measuring and cutting the plastic panel of the cap panel for insertion into the interior of a casket lid 26. The preferred adjustable cap panel is packaged in a large size that will fit most casket lids or allow the size of the cap panel to be reduced to fit most casket lids. The fabric covering 8 of the cap panel overlaps across the back of the panel to provide sufficient excess for pinning the fabric on the back of the panel. Upon reducing the size of the panel, the excess fabric will further overlap the panel back as shown in FIG. 1B.

The adjustable cap panel kit 2 provides a method for fitting various style and size caskets 28. In particular, the cap panel 6 may be reduced in size to fit the central area surrounded by a casket lid frame 30 on the underside of a casket lid 26. After removing the cap panel element from its frame 24 or packaging 4, the fabric covering 8 is removed and the measuring device 16, such as a tape measure, is used to size the cap panel 6 with relation to the available opening in the casket lid 26. The cap panel is measured to correlate with the casket lid with some excess left for tucking the edges of the cap panel beneath the framing 30 or puffing of the casket lid's underside. The measured cap panel is cut using a cutting device and then re-wrapped with the fabric covering. The covering overlapping the rear of the cap panel is pinned or attached, which may be accomplished using pins 10 included within the kit. Once the cap panel is cut to size and recovered, the cap panel may be inserted into the central portion of the casket lid frame 30 on the underside of the casket lid 26. Adhesive backing on the hook and loop fasteners 12 included in the kit may be removed, whereby a first portion of the hook and loop fasteners will adhere to the casket lid and a second portion will adhere to the cap panel. The cap panel of this invention will be easily tucked under the framing or puffing on the casket lid, and the puffing and hook and loop fasteners will hold the cap panel securely in place.

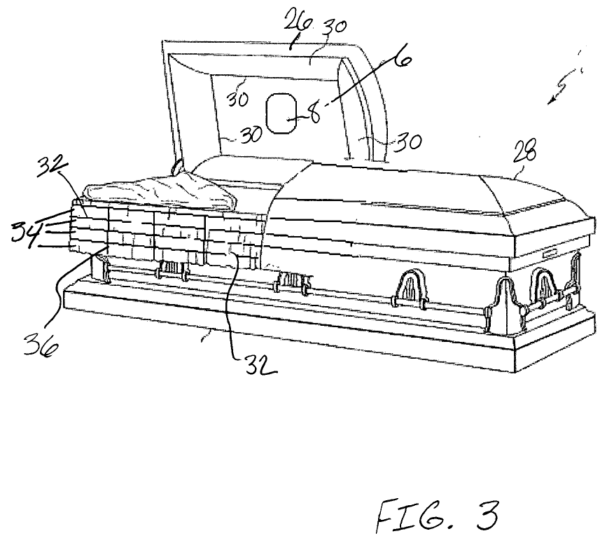

The cap panel 6 and accessories may be held in a display frame 24 for display on a wall or other location prior to the need for the cap panel and accessories for funeral arrangements. In the particular embodiment of FIG. 2, the cap panel is framed with its fabric covering 8 in place on the panel for viewing through a transparent glass covering. A portion of the kit content, such as measuring device 16, instructions 18 and tucking device 14, will be contained between the frame's backing and the cap panel. Additional elements of the kit, including a pillow cover 20 and casket drape 22, may be ornamentally folded and arranged between the glass covering and the cap panel for prominent display along with the cap panel. Upon need, the frame backing is removed to reveal the elements of the kit for removal. The cap panel is then adjusted and inserted into the central area of the casket lid 26 in accordance with the instructions, and the pillow cover and casket drape assembled on the casket 28. FIG. 3 illustrates the arrangement described. After the services are held, the cap panel may be left in the casket permanently or removed to provide a memorial to the deceased. In particular the cap panel may be reinserted in the frame for memorial display.

The casket drape 22 shown includes a plurality of pockets 32 for insertion of notes or other memorabilia during a funeral service. In the present embodiment, sixteen pockets are formed by sewing four progressively larger strips of fabric 34 lengthwise across a particular section or lower portion of a fabric block that comprises the drape. The larger strips are sewn with a perpendicular seam 36 to their lengthwise orientation on the block to provide for vertically oriented pockets. Using three seems spaced equidistantly apart will provide for the sixteen pockets of progressive depth as shown. In practice, the drape 22 folds about the central portion of the block, and the plain portion not comprising the pockets laps over the edge of the open casket 28 into the interior bed area of the casket. The plain portion of the drape tucks into the edge of the casket bed to securely hold the drape. The pocketed portion of the drape hangs on the exterior side of the casket such that the pockets are exposed for insertion of notes and other items.

Although the invention has been described in connection with a preferred embodiment thereof, it will be appreciated by those skilled in the art, that additions, modifications, substitutions, and deletions not specifically described may be made without departing from the spirit or scope of the invention as defined in the appended claims.

What is claimed is:

1. A method for providing a cap panel for a casket comprising the steps of:
covering an adjustable panel in a decorative fabric;
measuring a central area on a lid of the casket where the cap panel will be displayed between the framing on the lid's underside when the lid is opened;
removing the decorative fabric from the adjustable panel;
measuring and cutting the adjustable panel as needed for use in accordance with the specific sized central area on the lid of the casket in such a configuration that the adjustable cap panel will be displayed during funeral services;
re-covering the adjustable panel with the decorative fabric; and
inserting the adjustable cap panel onto the casket lid by tucking the adjustable cap panel into a framing area situated about the central area on the lid.

2. A method for providing a cap panel for a casket as in claim 1 comprising the additional steps of framing the adjustable panel in a frame for display after the step of covering the adjustable panel in a decorative fabric and removing the adjustable panel from the frame for use upon need for the casket before the step of removing the decorative fabric from the adjustable panel.

3. A method for providing a cap panel for a casket as in claim 2 comprising the additional step of storing a measuring device, tucking device, and instructions between the adjustable panel and a frame backing for removal upon removing the adjustable panel from the frame for use upon need for the casket.

4. A method for providing a cap panel for a casket as in claim 2 comprising the additional combination step of framing with the adjustable panel a pillow cover and casket drape for storage and display until removal of the adjustable panel from the frame for use upon need for the casket.

5. An adjustable cap panel kit for assembling an adjustable cap panel for use in caskets upon need comprising:
a panel of flexible and pliable plastic or board material;
a measuring device;
a removable decorated fabric covering for covering the panel;
pinning devices; and
hook and loop fasteners with adhesive backing.

6. An adjustable cap panel kit as in claim 5 in which the measuring device is a tape measure.

7. An adjustable cap panel kit as in claim 5 that further includes a cutting device.

8. An adjustable cap panel kit as in claim 5 that further includes a tucking device.

9. An adjustable cap panel kit as in claim 5 that further includes a wood frame suitable for framing the panel.

10. An adjustable cap panel kit as in claim 5 that further includes a pillow cover and a casket drape.

11. An adjustable cap panel kit as in claim 10 in which the casket drape includes a plurality of pockets.
